(19) United States
(12) Patent Application Publication
(10) Pub. No.: US 2012/0282866 A1
(43) Pub. Date: Nov. 8, 2012

(54) RADIO TRANSCEIVER ARCHITECTURE

(75) Inventor: Ian Vernon Thompson, Christchurch (NZ)

(73) Assignee: TAIT LIMITED, Christchurch (NZ)

(21) Appl. No.: 13/465,664

(22) Filed: May 7, 2012

Related U.S. Application Data
(60) Provisional application No. 61/482,955, filed on May 5, 2011.

(51) Int. Cl. H04B 1/40

(52) U.S. Cl. 455/74

(57) ABSTRACT

A radio transceiver architecture having transmitter and receiver paths. The receiver path has a frequency down conversion stage which creates an incoming IF signal from an incoming RF signal. The transmitter path has a frequency up conversion stage which creates an outgoing RF signal from an outgoing IF signal and a feedback IF signal. The feedback IF signal is created from the outgoing RF signal by the frequency conversion stage in the receiver path.

### RELATED APPLICATIONS

This application claims benefit of U.S. Provisional Application No. 61/482,955, titled “Radio Transceiver Architecture,” filed May 5, 2011, which is incorporated by reference herein in its entirety.

### BACKGROUND TO THE INVENTION

This invention relates to radio transceiver architectures and methods of operating a radio transceiver, and in particular but not only, to an architecture and method for terminals or base stations in a mobile radio network.

A radio transceiver is a combined transmitter and receiver having switching capabilities for selecting either the transmitting or receiving functions, usually to operate in half duplex. The receiver typically combines an incoming radio frequency (RF) signal with a local oscillator signal to provide an intermediate frequency (IF) signal. The IF signal is more readily filtered and amplified than the RF signal and can then be converted to a baseband signal. A zero-IF receiver converts the RF signal directly to a baseband signal. The transmitter or signal generation system typically uses a voltage controlled oscillator (VCO) in a phase locked loop (PLL) to generate a relatively high frequency outgoing RF signal. The signal from the VCO can be modulated with a baseband signal and is then amplified before transmission. Alternative modulation methods may also be used.

A problem often encountered in design of transceiver architecture is the provision of local oscillators with acceptable noise performance. This problem is exacerbated when extended VCO frequency coverage is required. Further, a PLL having a control loop with large bandwidth can also generate undesirable noise levels. Many transceivers use multiple switched VCOs to provide a required frequency range but these can also be a problem when there are constraints on space and complexity.

### SUMMARY OF THE INVENTION

It is therefore an object of the invention to provide an improved transceiver architecture which partly combines the functionality of the transmitter and receiver to overcome one or more of these design constraints, or at least to provide a more useful alternative to existing transceivers.

The invention resides in a radio transceiver including: a receiver path having a frequency down conversion stage which creates an incoming IF signal from an incoming RF signal, and a transmitter path having a frequency up conversion stage which creates an outgoing RF signal from an outgoing IF signal and a feedback IF signal, wherein the feedback IF signal is created from the outgoing RF signal by the frequency conversion stage in the receiver path. The frequency conversion stages may each include multiple stages.

Preferably the receiver path includes one or more mixers which mix an oscillator signal with the incoming RF signal to create the incoming IF signal or which mix the oscillator signal with the outgoing RF signal to create the feedback signal. Preferably the transmitter path includes a phase comparator which compares the outgoing IF signal and the feedback IF signal, and an oscillator which is controlled by the phase comparator to generate the outgoing RF signal.

Preferably the transceiver includes a first switch which passes either the incoming RF signal or a sample of the outgoing RF signal to the receiver path, and a second switch which passes the incoming IF signal to either the transmitter path as the feedback IF signal, or to a demodulation stage. The receiver path may also include a noise and/or frequency drift cancellation stage.

In another aspect the invention resides in a method of operating a radio transceiver, including the steps of: a) operating the transceiver in a reception mode, including: a1) receiving an incoming RF signal, a2) converting the incoming RF signal to an incoming IF signal using a frequency down conversion stage; and b) operating the transceiver in a transmission mode, including: b1) generating an outgoing IF signal, b2) converting the outgoing IF signal into an outgoing RF signal using a frequency up conversion stage and a feedback IF signal, b3) creating the feedback IF signal from the outgoing RF signal using the frequency conversion stage in (a2), and b4) transmitting the outgoing RF signal.

Preferably the frequency down conversion stage includes one or more mixers and IF stages which, in the reception mode of the transceiver, mix an oscillator signal with the incoming RF signal to create the incoming IF signal, and in the transmission mode of the transceiver, mix the transmitter oscillator signal with the outgoing RF signal to create the feedback IF signal. Preferably the frequency up conversion stage includes a phase comparator which compares the outgoing IF signal and the feedback IF signal, and an oscillator which is controlled by the phase comparator to generate the outgoing RF signal according to the phase difference between the outgoing IF signal and feedback IF signal.

### BRIEF DESCRIPTION OF THE DRAWINGS

Preferred embodiments of the invention will be described with respect to the accompanying drawings, in which:

FIG. 1 shows a transceiver with constant envelope modulation,

FIG. 2 shows an alternative transceiver with I/Q modulation, and

FIG. 3 shows a transceiver with noise cancellation.

### DETAILED DESCRIPTION OF THE INVENTION

Referring to these figures, it will be appreciated that the invention can be implemented in a variety of ways for a range of different RF systems. The transceiver embodiments described here are given by way of example only.

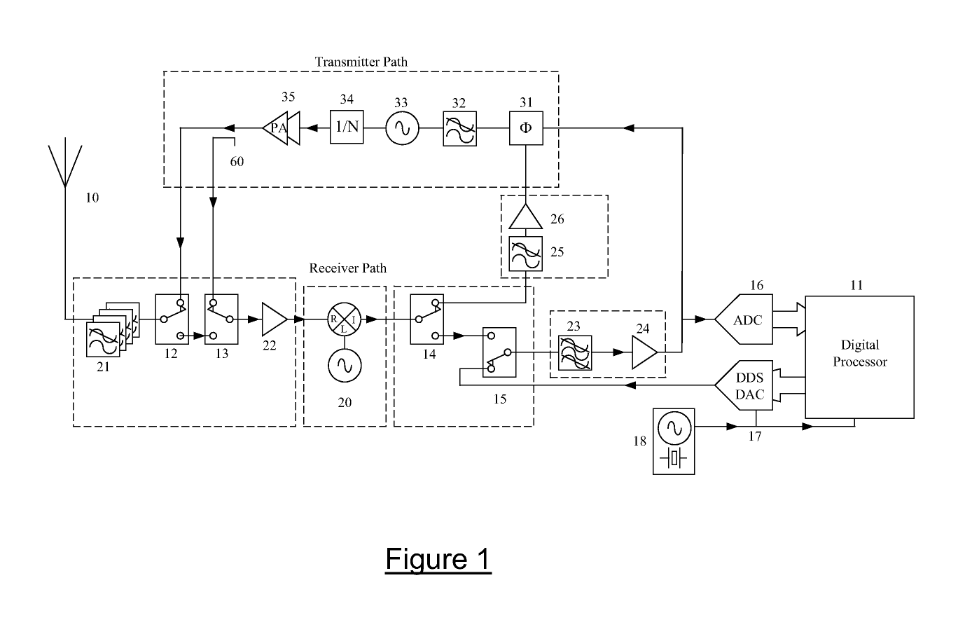

FIG. 1 shows a transceiver architecture having a receiver path and a transmitter path connected between a common antenna 10 and a digital processor 11. In this configuration of the transceiver the outgoing signal has constant envelope modulation while the incoming signal could have either constant or non-constant envelope modulation.

In FIG. 1, front end switches 12, 13 and back end switches 14, 15 enable the transceiver to provide a reception mode or a transmission mode for incoming or outgoing RF signals respectively. In this example the four switches are set for transmission mode and each would be reversed to provide the reception mode. In reception mode an incoming RF signal from the antenna is down converted to an incoming IF signal by stage 20 in the receiver path, and then further converted by analogue to digital converter (ADC) 16 to form a digital signal for the processor, typically but not necessarily into a baseband signal. In transmission mode a baseband signal is generated by the processor and converted by direct digital synthesiser (DDS) 17 to form an outgoing IF signal. The outgoing IF signal is further up converted by the transmitter path to form an outgoing RF signal for the antenna. A reference crystal oscillator 18 provides timing for the processor 11 and the synthesisers 17 and the local oscillator contained within 20.

The receiver path in FIG. 1 includes a frequency down conversion stage 20, having a mixer and a local oscillator, which converts the incoming RF signal from the antenna into the incoming IF signal. In this example the down conversion stage involves a simple combination of mixer and oscillator, but could be more complex using a mixture of local oscillator and IF stages. The receiver path includes front end components such as filters 21 and an amplifier 22, in addition to the switches 12, 13, depending on overall system requirements. The receiver path further includes IF components such as a band pass filter 23 and amplifier 24 when the transceiver is in reception mode. Switches 14, 15 alternately connect the receiver path to the transmitter path through filter 25 and amplifier 26 when the transceiver is in transmission mode.

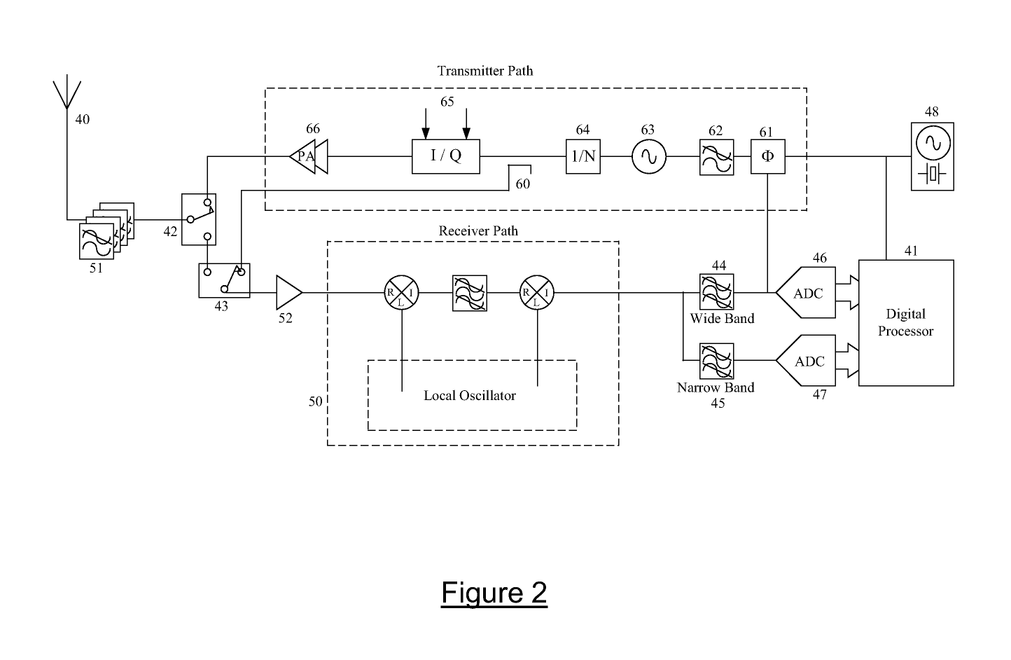

The transmitter path in FIG. 1 provides frequency up conversion by way of a phase locked loop (PLL) which uses feedback through part of the receiver path. A signal tap 60 in the transmitter path conveys the outgoing RF signal through switch 13 into the receiver path for down conversion by stage 20. Signal tap 60 located in each of FIGS. 1 and 2 is by way of example only and could be repositioned to convey an alternative feedback signal to the receiver path. Filter 25 and amplifier 26 then convey the resulting signal as a feedback IF signal into the transmitter path. The up conversion and down conversion stages are set so that the frequencies of the feedback IF signal and the outgoing IF signal are matched. The PLL includes a phase detector 31 which compares the outgoing IF signal from synthesiser 17 with the feedback IF signal and produces an error signal. A loop filter 32 passes the error signal to a voltage controlled oscillator (VCO) 33. The resulting RF signal from the VCO may be reduced in frequency by a divider 34, if required, and passed through a power amplification stage 35. Switch 12 delivers the outgoing RF signal to the antenna. Modulation can be applied to the signal produced by the VCO either through the digital synthesiser 17 as shown, or via an equivalent analogue modulation source, or via the feedback IF signal for example. Optional amplitude modulation could simultaneously be applied through the power amplifier. ADC 16 could be used as part of a digitally controlled feedback system that corrects modulation non-linearities before the signal is applied to the transmitter detector 31.

FIG. 2 shows an alternative transceiver architecture having a receiver path and a transmitter path connected between a common antenna 40 and a digital processor 41. In this configuration the transceiver is able to apply complex (I/Q) modulation to outgoing signals.

In FIG. 2 a pair of front end switches 42, 43 enable the transceiver to provide a reception mode or a transmission mode for incoming or outgoing RF signals respectively. This example shows the switches set for transmission mode and each would be reversed to provide the reception mode. In reception mode, an incoming RF signal from the antenna is down converted to an incoming IF signal by the receiver path, passed through wide band or narrow band filter 44 or 45, and then further converted by analogue to digital converter 46 or 47 to form a digital signal for the processor. The filter, converter combinations 44, 46 and 45, 47 may be used as wide band and narrow band alternatives if required. In transmission mode, a phase locked loop is used to create the outgoing RF signal for the antenna.

The receiver path in FIG. 2 includes a generic example frequency down conversion stage 50 comprising two mixers which convert the incoming RF signal from the antenna into the incoming IF signal. The receiver path includes front end components such as filters 51 and an amplifier 52, in addition to the switches 42, 43 and filters 44, 45 again depending on overall system requirements.

The transmitter path in FIG. 2 includes a PLL which uses VCO 63 to generate an RF signal and uses feedback through part of the receiver path. The VCO can be operated at a frequency several times the eventual outgoing RF signal if required using the divider 64. A signal tap 60 in the transmitter path conveys the outgoing RF signal through switch 43 into the receiver path for down conversion by stage 50. The filter 44 then conveys the resulting signal as a feedback IF signal into the transmitter path. The PLL includes a phase detector 61 which compares the outgoing IF signal, in the form of a reference signal from oscillator 48, with the feedback IF signal and produces an error signal. A loop filter 62 having a relatively wide bandwidth passes the error signal to the VCO. The resulting RF signal may be reduced in frequency by a divider 64, if required. A baseband signal, typically generated by the processor 41, is applied to the RF signal in an I/Q modulation stage 65 to form the outgoing RF signal. A power amplifier 66 amplifies the outgoing RF signal as required. Switch 42 then delivers the outgoing RF signal to the antenna. While coupler 60 is shown placed prior to PA 66, this coupler could be placed after PA 66 which facilitates using digital processor 41 in a closed-loop error correction system.

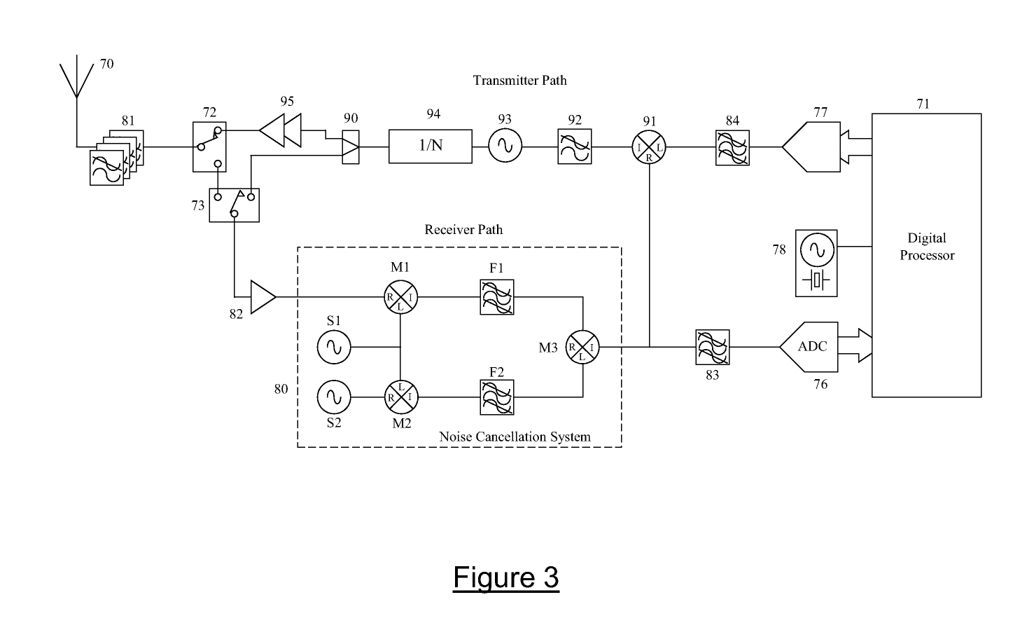

FIG. 3 shows a preferred transceiver architecture in which the receiver path includes noise cancellation. A receiver path and a transmitter path are connected between a common antenna 70 and a digital processor 71. The outgoing signal uses constant envelope modulation as in FIG. 1.

In FIG. 3, a pair of front end switches 72, 73 enable the transceiver to provide a reception mode or a transmission mode for incoming or outgoing RF signals respectively. In this example the switches are set for transmission mode and each would be reversed to provide the reception mode. In reception mode an incoming RF signal from the antenna is down converted to an incoming IF signal by the receiver path, and then further converted by analogue to digital converter 76 to form a digital signal for the processor. In transmission mode a baseband signal is generated by the processor and converted by direct digital synthesiser 77 to form an outgoing IF signal. The outgoing IF signal is filtered 84 and then further up converted by the transmitter path to form an outgoing RF signal for the antenna. A reference crystal oscillator 78 provides timing requirements.

The receiver path in FIG. 3 includes a frequency down conversion stage 80, having one or more mixers and local oscillators, which converts the incoming RF signal from the antenna into the incoming IF signal, depending upon the required system frequency coverage. In this example the down conversion stage also provides noise and drift cancellation as described below. The receiver path includes front end components such as filters 81 and an amplifier 82, in addition to the switches 72, 73, depending on overall system requirements. The receiver path further includes IF components such as a band pass filter 83.

The transmitter path in FIG. 3 provides frequency up conversion by way of a phase locked loop (PLL) which uses feedback through part of the receiver path. A signal splitter 90 in the transmitter path conveys the outgoing RF signal through switch 73 into the receiver path for down conversion by stage 80. An output of stage 80 then conveys the resulting signal as a feedback IF signal into the transmitter path while optionally a closed loop modulation error correction system using digital processor 71 can be created. In this example the up conversion and down conversion stages are set so that the frequencies of the feedback IF signal and the outgoing IF signal are nominally matched although this is not a necessity in this configuration. The PLL includes a phase detector 91 which compares the outgoing IF signal with the feedback IF signal and produces an error signal. A loop filter 92 passes the error signal to a voltage controlled oscillator (VCO) 93. The resulting RF signal from the VCO may be reduced in frequency by a divider 94, if required, and passed through a power amplifier 95. Switch 72 delivers the outgoing RF signal to the antenna. The combination of the receiver local oscillator and IF signal frequencies determine the transmitted signal frequency.

The down conversion stage 80 in FIG. 3 is configured to cancel phase noise and frequency drift which is introduced by signal source S1, and enables the transceiver to operate with a relatively high performance in both the reception and transmission modes. The signal at the input to stage 80 is either an incoming RF signal from the antenna or a sample of the outgoing RF signal from the transmitter path and is converted to an IF signal at the output of stage 80. The IF signal at the output of stage 80 either proceeds in the receiver path or becomes the feedback IF signal for the transmitter path.

In this example, signal source S1 produces a frequency which is substantially higher than the signal at the input to stage 80 and contains phase noise or may fluctuate in frequency. Signal source S2 produces a frequency substantially lower than S1 and therefore exhibits relatively less noise. Signal source S1 is combined with the input to stage 80 in mixer M1 to produce a high side intermediate signal containing the noise and/or drift from S1. Signal source S1 is combined with signal source S2 in mixer M2 to produce a low side intermediate signal also containing the noise and drift from S1. These high and low side signals are filtered as required by filters F1 and F2 respectively, and may also be amplified. The low side signal is then subtracted from the high signal in mixer M3 to eliminate the noise and drift from source S1 and produce an output signal having an intermediate frequency which is the difference between the signal from source S2 and the input to stage 80.

By way of more specific example, the transceiver may be placed in reception mode at an incoming RF signal of 400 MHz by setting S1 and S2 to produce 1500 MHz and 500 MHz respectively, so that the high and low side signals from mixers M1 and M2 are at 1100 MHz and 1000 MHz. The signal from M3 is then 100 MHz and is independent of noise and drift in S1. Source S2 may be set to the input frequency plus or minus the intended output frequency, so that S2 may alternatively be set to 300 MHz. When placed in transmission mode, with an outgoing RF signal of 400 MHz, the reference signal for the PLL is modulated and set to the output frequency of stage 80, and the VCO 93 is locked to 400 MHz. The loop bandwidth of the PLL is set sufficiently wide and divider 94 is set to N=1. However, VCO 93 could be set to an integer multiple of 400 MHz, say 2400 MHz, to further increase VCO 93 immunity to the transmitted signal by using divider 94 set to divide by 6. Other more elaborate schemes of offsetting the transmitter VCO frequency from that of the transmitted signal frequency could equally be used, that do not rely on an integer relationship between transmit VCO and output frequencies.

A transceiver architecture of the present kind may be configured to enable both multiband and non-multiband frequency coverage and to employ both narrow and wide band modulation formats. The architecture may also be readily implemented on integrated circuits.

It should also be appreciated that the term “radio transceiver” or “transceiver” applies equally to any combination of signal receiver or signal generation systems and is therefore not limited to radio architectures. Further, while the common perception in a “transmitter” is up conversion the concepts disclosed herein apply equally to any combination of up and down conversion stages. Although the final receiver stage is referred to as an IF stage, this definition applies equally to a “low RF signal frequency” or a “Zero-IF signal” and then using an IQ demodulator as the final mixer element. The implementation of this final stage is not critical.

These architectures may be able to transceive wide band data and simultaneously receive multiple signals within a given bandwidth, perhaps encompassing different radio standards. In FIG. 3 the S2 local oscillator lock time will define the system's lock time and hence frequency agility. The combined noise and frequency drift cancellation of S1 means that this local oscillator's lock time does not feature in the overall system lock time. The architectures may therefore be suited to transceiver scanner applications where fast lock time and wide capture bandwidths complement one another to quickly scan large sections of frequency space.

These architectures may be used for either Cartesian or Polar (closed loop) error correction and/or pre-distortion. Thus it may be possible to separately apply phase modulation to the local oscillator and amplitude modulation to the power amplifier circuits then correct for any imbalances and distortion thereby introduced using this closed loop system. The applied modulation could be simple constant envelope or non-constant envelope (complex) modulation. As a consequence of the transmitter's dependency on the receiver path it is possible to apply constant envelope modulation to the receiver local oscillators.

In zero-IF receiver architectures the noise cancellation features may be effective because with two fixed frequencies (IF1 and IF2) applied to the zero IF mixer (or an IQ demodulator) it is (electrically) easier to optimise the system for troublesome second order inter-modulation products at this mixer. The second-order inter-modulation at the first mixer where S2 will be at the same frequency as the received signal.

The isolation of S2 from the transceiver connection (FIG. 3) means that there is much less S2 re-radiation from the antenna in both receive and transmit mode. Because S1 is noise and drift cancelled within FIG. 3, this local oscillator is ostensibly impervious to any outside interference that might corrupt it. For example, if S1 is co-located and on frequency with a powerful transmitter then S1 fidelity will be corrupted however, any S1 signal corruption will not affect the overall performance of the receiver.

The dividers (and not necessarily binary dividers) that follow the transmitter VCO allow this VCO to run at integer multiples of the desired transmitted output frequency, which potentially increases the transmitted VCO resilience to any unwanted parasitic feedback from the power amplifier and antenna radiation that could corrupt this VCO's correct operation.

1. A radio transceiver including:
a receiver path having a frequency down conversion stage which creates an incoming IF signal from an incoming RF signal, and
a transmitter path having a frequency up conversion stage which creates an outgoing RF signal from an outgoing IF signal and a feedback IF signal,
wherein the feedback IF signal is created from the outgoing RF signal by the frequency conversion stage in the receiver path.

2. A transceiver according to claim 1 wherein the receiver path includes one or more mixers which mix an oscillator signal with the incoming RF signal to create the incoming IF signal or which mix the oscillator signal with the outgoing RF signal to create the feedback signal.

3. A transceiver according to claim 1 wherein the transmitter path includes a phase comparator which compares the outgoing IF signal and the feedback IF signal, and an oscillator which is controlled by the phase comparator to generate the outgoing RF signal.

4. A transceiver according to claim 1 further including a first switch which passes either the incoming RF signal or a sample of the outgoing RF signal to the receiver path, and a second switch which passes the incoming IF signal to either the transmitter path as the feedback IF signal, or to a demodulation stage.

5. A transceiver according to claim 1 further including a modulator in the transmitter path which modulates the outgoing IF signal with a baseband signal before the frequency up conversion stage.

6. A transceiver according to claim 1 further including a modulator in the transmitter path which modulates the outgoing RF signal with a baseband signal after the frequency up conversion stage.

7. A transceiver according to claim 1 in which the receiver path includes a noise and/or frequency drift cancellation stage.

8. A transceiver according to claim 1 wherein the frequency down conversion stage includes multiple stages.

9. A transceiver according to claim 1 wherein the frequency up conversion stage includes multiple stages.

10. A method of operating a radio transceiver, including the steps of:
a) operating the transceiver in a reception mode, including:
a1) receiving an incoming RF signal,
a2) converting the incoming RF signal to an incoming IF signal using a frequency down conversion stage;
and
b) operating the transceiver in a transmission mode, including:
b1) generating an outgoing IF signal,
b2) converting the outgoing IF signal into an outgoing RF signal using a frequency up conversion stage and a feedback IF signal,
b3) creating the feedback IF signal from the outgoing RF signal using the frequency conversion stage in (a2), and
b4) transmitting the outgoing RF signal.

12. A method according to claim 10 wherein the frequency down conversion stage includes one or more mixers and IF stages which, in the reception mode of the transceiver, mix an oscillator signal with the incoming RF signal to create the incoming IF signal, and in the transmission mode of the transceiver, mix the transmitter oscillator signal with the outgoing RF signal to create the feedback IF signal.

13. A method according to claim 10 wherein the frequency up conversion stage includes a phase comparator which compares the outgoing IF signal and the feedback IF signal, and an oscillator which is controlled by the phase comparator to generate the outgoing RF signal according to the phase difference between the outgoing IF signal and feedback IF signal.

14. A method according to claim 10 further including switching the transceiver from the reception mode to the transmission mode by switching an input of the frequency down conversion stage from the incoming RF signal to the outgoing RF signal, and switching an output of the frequency down conversion stage from an input of an IF demodulation stage to an input of the frequency up conversion stage.

15. A method according to claim 10 further including switching the transceiver from the transmission mode to the reception mode by switching an input of the frequency down conversion stage from the outgoing RF signal to an incoming RF signal, and switching an output of the frequency down conversion stage from the frequency up conversion stage to an input of an IF demodulation stage.

16. A method according to claim 10 wherein the outgoing IF signal is modulated with an outgoing baseband signal after (b1) and before (b2).

17. A method according to claim 10 wherein the outgoing RF signal is modulated with an outgoing baseband signal after (b3) and before (b4).

18. A method according to claim 10 wherein the frequency down conversion stage includes a section for noise cancellation and/or drift cancellation in the feedback IF signal.

19. A method according to claim 10 wherein the frequency down conversion stage and the frequency up conversion stage include multiple stages.

20. A method according to claim 10 further including: a3) converting the incoming IF signal to a baseband signal.
